(19) United States
(12) Patent Application Publication
(10) Pub. No.: US 2011/0130082 A1
(43) Pub. Date: Jun. 2, 2011

(54) SUSPENSION APPARATUS FOR SUSPENDING STRINGS OF SAUSAGES

(75) Inventor: Peter Knodel, Oyten (DE)

(73) Assignee: VEMAG MASCHINENBAU GMBH, Verden/Aller (DE)

(21) Appl. No.: 12/901,632

(22) Filed: Oct. 11, 2010

(30) Foreign Application Priority Data
Oct. 12, 2009 (DE) 202009013829.1
May 6, 2010 (EP) 10162145.6

(51) Int. Cl. A22C 11/00

(52) U.S. Cl. 452/51

(57) ABSTRACT

The invention concerns an apparatus for suspending strings of sausages in loops, the apparatus including a guide and drive device for guiding and driving hooks along a path of movement. The guide and drive device includes a drivable circulating drive element for spaced receiving and driving a plurality of hooks. The apparatus also includes a plurality of hooks which can be coupled to the drive element for carrying a loop of the string of sausages. The apparatus further includes a fixing device for steplessly fixing the hooks at various spacing relative to each other on the drive element.

### TECHNICAL FIELD

The invention concerns a suspension apparatus for suspending strings of sausages.

### BACKGROUND

Small sausages are usually produced with known sausage filling machines in the form of long portioned sausage strings. Two adjacent sausage cases are respectively separated from each other by a twist-off location. The filled and divided sausage cases are then placed in loops and suspended from a conventional suspension device. A smoking bar or rod is pushed through the loops of the sausages, which are hanging in the suspension device. The string of sausages is then suspended in that form on a smoking cart, which is then moved into a smoker chamber.

When smoking sausages, an important consideration is that the sausages do not touch each other. Otherwise light spots remain after smoking at the points of contact, which not only detrimentally influence the external appearance of the sausages but also reduce the shelf life of the sausages. Therefore suspension devices have hooks at a predefined spacing so that the sausages can be hung up at so as to be spaced from each other. In conventional suspension devices the spacing of the hooks is fixedly predetermined at a predefined pitch.

However, sausages have differing thickness (caliber) so that, in known suspension devices, either there is an unnecessarily large spacing between the sausages or it is only possible to use every other hook because otherwise the sausages would strike against each other. Consequently, a smoker chamber cannot accommodate the optimum or maximum number of sausages.

The object of the present invention is to provide a suspension apparatus in which automatic adaptation to different sausage lengths and calibers can be effected.

### SUMMARY OF THE INVENTION

According to the invention, that object is attained by a suspension apparatus for suspending strings of sausages in loops, the apparatus including a guide and drive device for guiding and driving hooks along a path of movement. The guide and drive device has a drivable circulating drive element for receiving and for driving a plurality of spaced hooks. The suspension apparatus includes a plurality of hooks which can be coupled to the drive element for carrying a loop of the string of sausages, and a fixing device for steplessly fixing the hooks at various spacings relative to each other on the drive element.

Advantageously, the spacings of the hooks relative to each other are not predetermined by the suspension device but can be selected so that adjacent sausages can hang at the optimum spacing. The term “optimum spacing” is used herein to denote the smallest possible spacing between adjacent sausages, at which the sausages just no longer touch in order to give a good smoking result. To this end, the maximum possible number of sausages of any caliber can be accommodated in a suspension apparatus and thus in a smoker chamber.

In a preferred embodiment, the stepless fixing device has a gear wheel mounted rotatably on a hook and including teeth in engagement with corresponding recesses in the drive element. The gear wheel can be prevented from rotating by a locking device. The hooks can be displaced when the locking device is released. When the locking device is activated, the locking device prevents the positioned hooks from being displaced unintentionally.

It is advantageous if the gear wheel associated with the fixing device is rotatably mounted to a securing portion of the hook so that the axis of rotation of the gear wheel is arranged substantially vertically. That orientation of the gear wheel permits particularly simple displacement of the hooks along the guide and drive device of the suspension apparatus.

It is further preferred that the fixing device has a bolt which cooperates with a gear wheel. The bolt has a screwthread and can be fixed by a nut to a securing portion of a hook. That arrangement ensures particularly simple fixing of the hook to prevent the hook from being displaced unintentionally.

In a preferred embodiment, the securing portion of a hook is substantially U-shaped in a side view and the free limbs of the U-shaped portion cooperate with a guide rail of the guide and drive device. The guide rail thus guides the hooks along their path of movement. The U-shaped securing portion is also easy to manufacture.

In a preferred embodiment of the suspension apparatus, the guide rail has at least one substantially vertically arranged plate along which the hooks can slide.

It is preferred that the circulating drive element is a toothed belt or chain and the gear wheel is in positively locking engagement with teeth of the toothed belt or recesses in the chain.

The suspension apparatus according to the invention advantageously includes a hook which is movable so that the hook is displaceable in relation to the drive element into at least two positions. In this regard, the hook can be easily and quickly displaced from a first position into at least one second position. The hook is in the first position if it is not displaceable along the drive element. The hook may be moved to the second position by a short rotary or translatory movement of the hook relative to the drive element. In the second position the hook is freely displaceable along the drive element and can be freely positioned on the drive element. The movement can advantageously also be performed manually without involving a major application of force.

The suspension apparatus includes a hook which is mounted pivotally about an axis to a securing portion. Preferably the axis extends substantially parallel to the drive element. As a result, the hook may be easily displaced into the second position. The hook position may be altered with a small spacing between the at least two positions by a simple pivotal movement.

In one embodiment, the suspension apparatus includes a hook which in a first position is fixedly coupled to a first portion of the drive element. The hook is movable or pivotable into a second position in which the hook is uncoupled from the drive element and is displaceable relative thereto. In the second position, transmission of force from the drive element to the hook is enabled. In the first position of the hook, the drive force is transmitted both to the securing element and also to the hook, whereby the hook can also be driven slip-free even when carrying heavier loads.

Preferably in the first position the hook engages a groove into a first portion of the drive element. On a second portion of the drive element, the securing portion is coupled to the drive element by a groove. In a vertical orientation of the drive element, the first portion is disposed on the lower side of the drive element and the second portion on the upper side of the drive element. The grooves of the securing portion and the hook respectively enclose with their side walls the first and second portions of the drive element, thereby maintaining a permanent force-locking connection between the hook, the securing portion, and the drive element. Arranging the hook on a securing element and the force-locking relationship collectively secures the position of the hook on the drive element and makes a separate securing device for the hook superfluous.

Preferably the securing portion has two limbs arranged at a right angle to each other. The first limb includes a groove and a gear wheel and is positioned substantially vertically, parallel, and adjacent to the drive element. The first limb includes two side walls, between which the hook is mounted pivotally by at least one mounting in the side wall. This embodiment provides for pivotability of the hook in a particularly simple and reliable manner. In addition to the mounting, the side walls of the securing portion promote a perpendicular orientation of the hook relative to the drive element. During pivotal movement of the hook between the at least two positions, the side walls always hold the hook in the perpendicular orientation relative to the drive element. Therefore, the hook is pivoted relative to the drive element along an intended path of movement. In addition, the hook is displaceable in the second position relative to the drive element while remaining coupled to the drive element by the securing portion. Even if the hook is released from the drive element in the second position, the hook retains a defined position relative to the drive element. The hook is thus advantageously pivotable between the at least two positions manually. The drive element extends horizontally, which encourages a pivotal movement of the hook, which is advantageous ergonomically because the wrist can be kept vertical.

In another preferred embodiment, the drive element is provided with a plurality of sliding guide members respectively arranged on a first portion and a second portion of the drive element for guiding the hook and the securing portion in rail-like fashion along the longitudinal axis thereof. The sliding guide members include a securing sleeve for coupling to the drive element and a rail-like guide shoe formed on the securing sleeve. The guide shoes are configured such that the grooves of the securing portion can be brought into engagement with a groove in the guide shoes. The sliding guide members can be exchanged and selected to correspond to the configuration of the hooks. The sliding guide members therefore that different types of suspension members can be used on the guide and drive device.

In another preferred embodiment, the hook is held in the first position by a spring.

A further preferred embodiment of the suspension apparatus has a spring element installed within a substantially horizontally extending bore in the securing portion. The spring element is open to the drive element at the distal side of the securing portion.

In another embodiment, the hook is provided with a substantially vertical projection against which the spring element presses advantageously to ensure that the hook remains in the first position if no external moment acts on the hook other than that of the spring force about the pivot axis. Alternatively, the hook may be held in the first position by a coil spring oriented concentrically relative to the pivot axis.

In a further advantageous embodiment of the suspension apparatus, the hook prevents the rotary movement of a gear wheel rotatably mounted on the securing portion in the first position and enables the rotary movement of the gear wheel in the second position. As a result, displacement of the hook in the second position can be performed in a particularly stable manner. The gear wheel is disposed in engagement with the drive element both in the first and the second position of the hook. In a blocked position of the gear wheel, the drive force of the drive element is transmitted by the gear wheel to the securing portion and the hook. When the rotary movement of the gear wheel is enabled and the hook is to be displaced along the drive element, the gear wheel ensures that the hook is always displaced jointly with the securing portion parallel to the drive element and maintains the line of movement.

In addition, the hook can be oriented at an abutment. The hook can be precisely adjusted on the drive element by the abutment without having to use measurement tools or the like.

A particularly preferred embodiment of the suspension apparatus has an abutment which is displaceable into a position in which the hook can be oriented at the abutment. To this end, the abutment is positioned so that the hook in the second position can be oriented at the abutment. Thus, the hook can be efficiently adjusted along the drive element. For positioning the hook at a given location on the drive element, it is sufficient for the hook to be moved into the second position and then oriented at the abutment. When the hook is in the first position, the hook can be moved past the abutment without further adjustments. Alternatively, after orientation of the hook, the abutment may be displaced into a position in which the abutment no longer crosses over with the hook. Particularly in the case of hooks which are only movable relative to the abutment, the abutment affords an advantageous rapid orientation of the hooks.

In a further aspect of the invention, a method of adjusting an apparatus for suspending strings of sausages is provided. The apparatus has a guide and drive device for guiding and driving hooks along a path of movement with a circulating drive element for receiving and for driving a plurality of spaced hooks which can be coupled to the drive element for carrying a loop of a string of sausages. The method includes:

positioning an abutment in a reference position,
displacing a hook into a second position in which the hook is uncoupled from the drive element and is displaceable relative to the drive element,
moving the hook to the abutment,
displacing the hook into a first position in which the hook is fixedly coupled to the drive element, and
moving the hook in a drive direction by a desired distance past the abutment.

In the method, the guide and drive device can be quickly and reliably equipped with a hook. Adjustment of the hook on the guide and drive device can be accomplished both manually and by machine.

In the method, the abutment can be automatically displaced into the reference position by a control and drive device.

In the method, superfluous hooks are removed from the guide and drive device after displacement of the hook into the second position or alternatively, missing hooks are added to the drive element in the second position. Consequently, the guide and drive device is quickly and easily equipped with the desired number of hooks for suspending the string of sausages.

By repetition of the aforementioned method steps for further hooks, the guide and drive device is equipped with a maximum number of hooks at a defined spacing relative to each other.

### BRIEF DESCRIPTION OF THE DRAWINGS

Advantageous embodiments of the invention are described with reference to the accompanying drawings.

FIG. 1 shows a side view of a machine for producing sausage goods comprising a filling machine, an accessory device and a suspension apparatus.

FIG. 2a shows a side view of a portion of the suspension apparatus of FIG. 1 with a first hook spacing.

FIG. 2b shows a side view of a portion of the suspension apparatus of FIG. 1 with a second hook spacing.

FIG. 3 shows a perspective view of a portion of a suspension apparatus in accordance with a first embodiment.

FIG. 4 shows a plan view of a suspension apparatus in accordance with the first embodiment.

FIG. 5 shows a side view of a hook of the suspension apparatus in accordance with the first embodiment.

FIG. 6a shows a plan view of a portion of a suspension apparatus in accordance with the first embodiment with two hooks at a first spacing.

FIG. 6b shows a plan view of a portion of a suspension apparatus in accordance with the first embodiment with two hooks at a second spacing.

FIG. 7a shows adjustment of the spacing of two hooks in a first manner.

FIG. 7b shows adjustment of the spacing of two hooks in a second manner.

FIG. 8 shows a perspective view of a portion of a suspension apparatus according to another embodiment with a drivable chain.

FIG. 9a shows a perspective view of a portion of the pivotable suspension apparatus according to yet another embodiment in a non-pivoted first position.

FIG. 9b shows an enlarged view of a portion of the suspension apparatus of FIG. 9a.

FIG. 10a shows a perspective view of a portion of the pivotable suspension apparatus of FIG. 9a in a pivoted second position.

FIG. 10b shows an enlarged view of a portion of the suspension apparatus of FIG. 10a.

FIG. 11a shows a sectional view of the suspension apparatus of FIG. 9a in the first position.

FIG. 11b shows a sectional view of the suspension apparatus of FIG. 9a in the second position.

### DETAILED DESCRIPTION

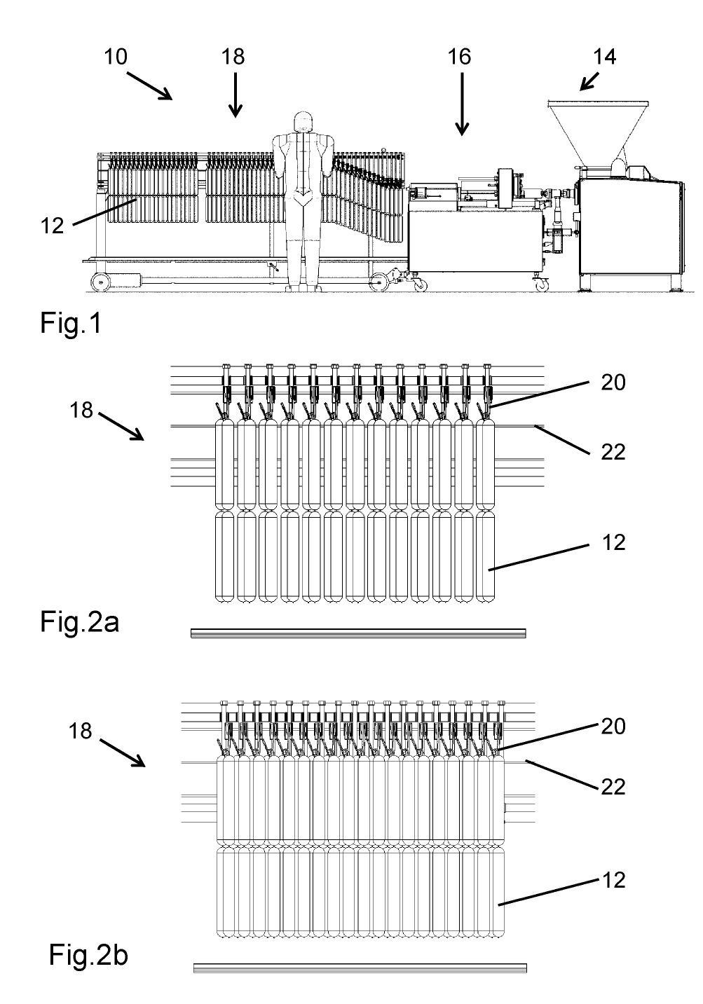

FIG. 1 shows a machine 10 for producing and processing sausage goods 12 comprising a filling machine 14, an accessory device 16, and a suspension apparatus 18.

The sausage material is filled into a sausage case in known manner in the filling machine 14, and divided up. Then the filled and divided sausage cases are suspended in freely hanging mutually juxtaposed relationship on a loop in the suspension apparatus 18. For that purpose, as shown in FIGS. 2a and 2b, hooks 20 on which the sausages 12 can be hung are provided on the suspension apparatus 18.

FIG. 2a shows the hooks each having a non-optimal, wide hook spacing, and FIG. 2b shows the hooks having an optimum close spacing. A smoking bar 22 can be passed through the loops of the sausages 12 in order to remove the sausages from the suspension apparatus 18 and hang them in a smoking cart for a smoking operation.

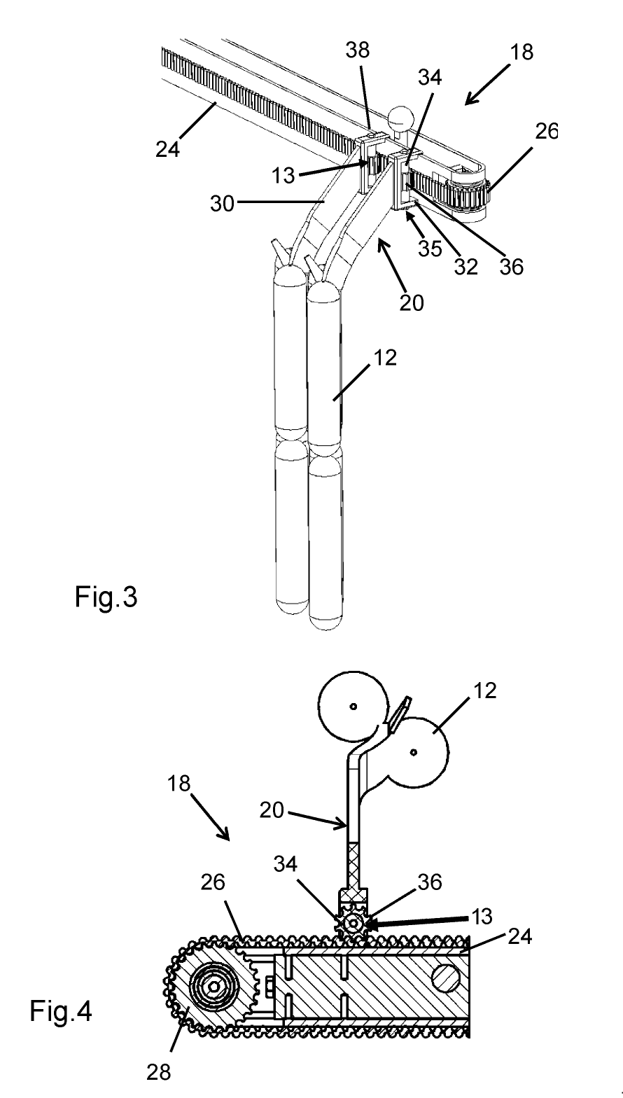

FIG. 3 shows a portion of a suspension apparatus 18 in accordance with a preferred embodiment of the invention. A toothed belt 26 is arranged along a guide rail 24 which here is in the form of vertical plates. The toothed belt 26 is driven by a drive wheel 28 shown in FIG. 4.

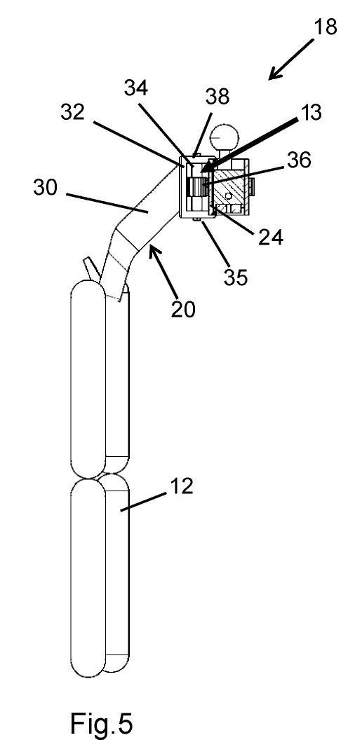

The hooks 20 are arranged on the guide rail 24. Each hook 20 has a suspension portion 30 for the sausages and a securing portion or slider 32, wherein the securing portion or slider 32 is directed towards the guide rail 24. As can be seen in FIG. 5, the securing portion 32 is in the form of a U-shaped slider, the opposing limbs of which cooperate with the guide rail 24. The securing portion or slider 32 can be displaced along the guide rail 24.

Disposed between the two opposing limbs of the securing portion or slider 32 perpendicularly thereto is a fixing device 13 including a freely rotatable shaft 34. A gear wheel 36 is arranged around the shaft 34 and fixedly connected thereto. The gear wheel 36 engages the toothed belt 26. The gear wheel 36 and thus the hook 20 are fixed relative to the toothed belt 26 by a bolt 38 having a screwthread which cooperates with the shaft 34 and which can be fixed to the slider 32 by means of a nut 35.

If the position of a hook 20 on the guide rail 24 is to be altered, the shaft 34 is released by the nut 35 and the bolt 38 being released so that the shaft 34 and thus the gear wheel 36 can rotate freely. The slider 32 can now be manually displaced along the guide rail 24 while the gear wheel 36 rotates to follow the toothed belt 26. When the hook 20 is at the desired position on the guide rail 24, the shaft 34 is fixed again by the bolt 38 and the nut 35. A tooth of the gear wheel 36 engages into a gap between the teeth of the toothed belt 26 in the fixed position.

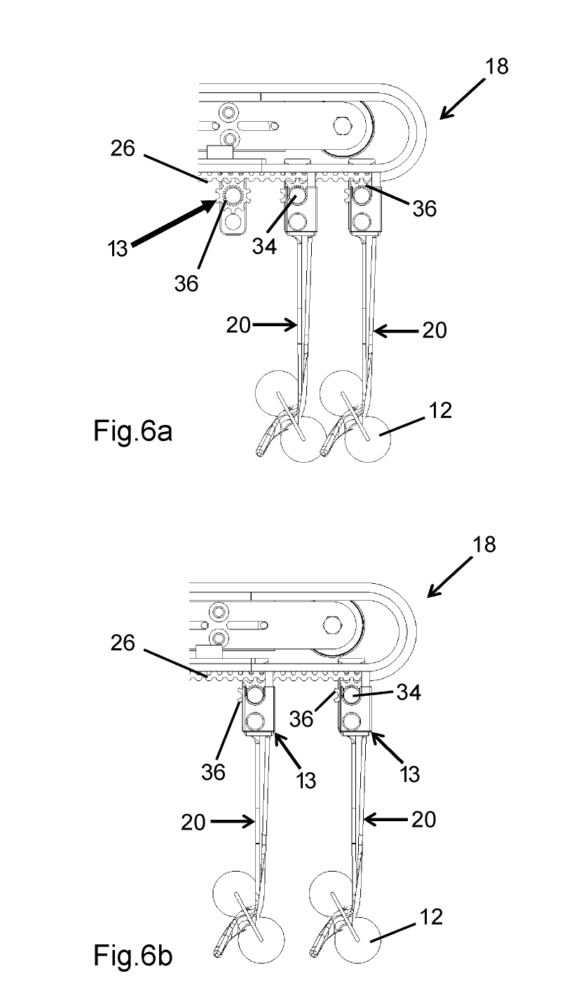

According to the invention, each hook 20 can be steplessly positioned and fixed by the fixing device 13 at any position on the toothed belt 26 so that the spacing between two hooks 20 is appropriate for the caliber size of the sausages 12 to be suspended and is independent of the nature of the suspension system. Depending on the caliber size of the sausage 12 to be suspended, the spacing between two hooks 20 can be small as shown in FIG. 6a or large as shown in FIG. 6b. A hook 20 is fixed in the set position on the toothed belt 26 by the fixing device 12 by tightening the nut 35 and the bolt 38.

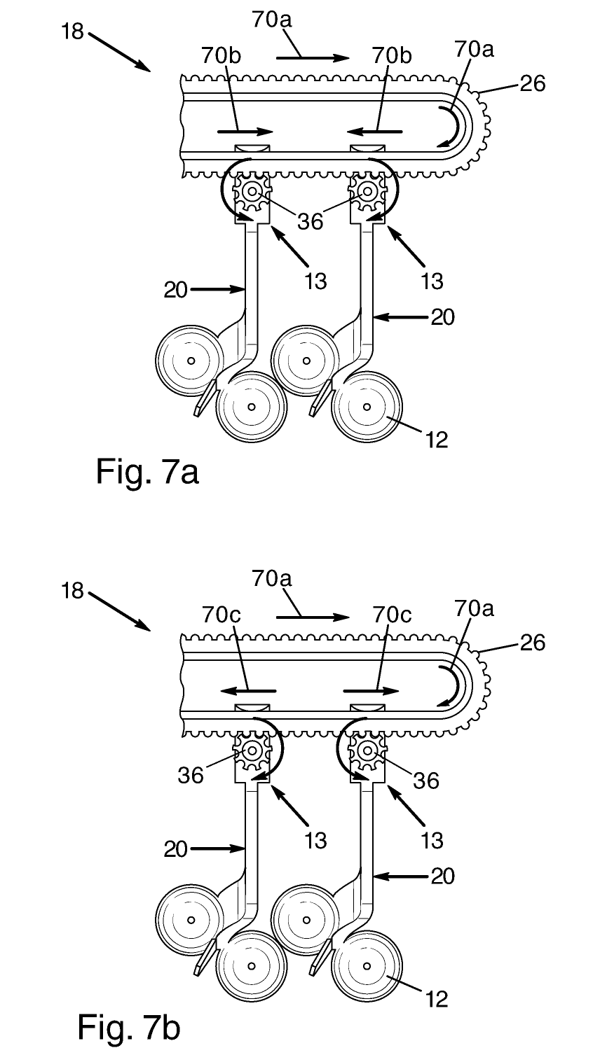

As can be seen from FIGS. 7a and 7b each hook 20 can therefore be displaced both in the direction of movement of the toothed belt 26 (as indicated by arrow 70a) and also in opposite relationship to that movement direction. Consequently, two hooks 20 can be moved either towards each other (as shown by arrows 70b in FIG. 7a) or away from each other (as shown by arrows 70c in FIG. 7b).

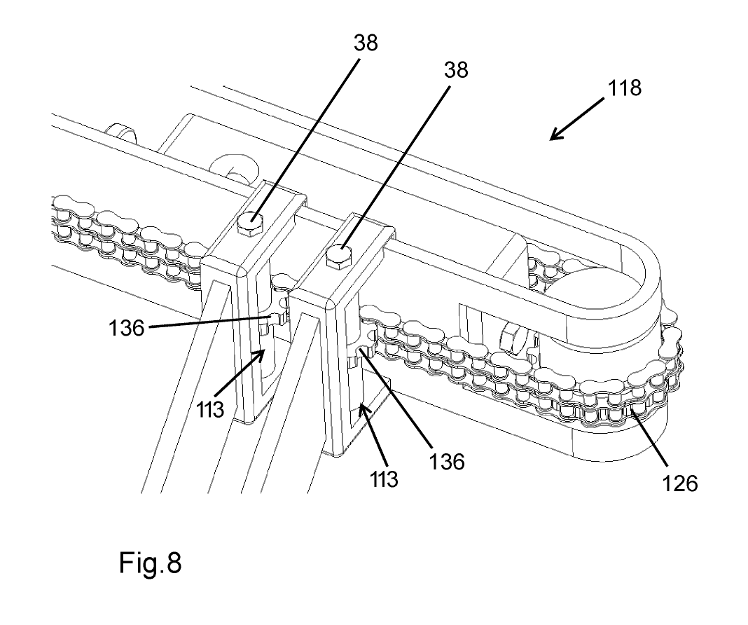

FIG. 8 shows an alternative embodiment of a suspension apparatus 118. Instead of the toothed belt 26 of the first embodiment, this apparatus 118 includes a chain 126 with recesses into which the teeth of a gear wheel 136 on a fixing device 113 engage. The mode of operation of this suspension apparatus 118 does not differ from that of the first embodiment described above.

It will be appreciated that, in place of the bolt 38, any other kind of releasable fixing for the fixing device 13, 113 is possible.

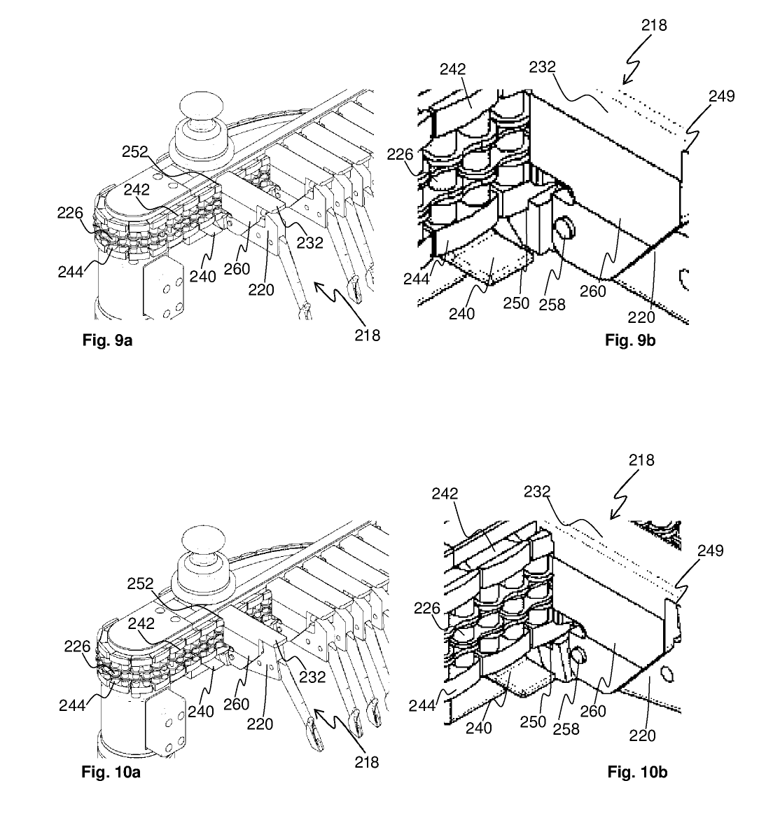

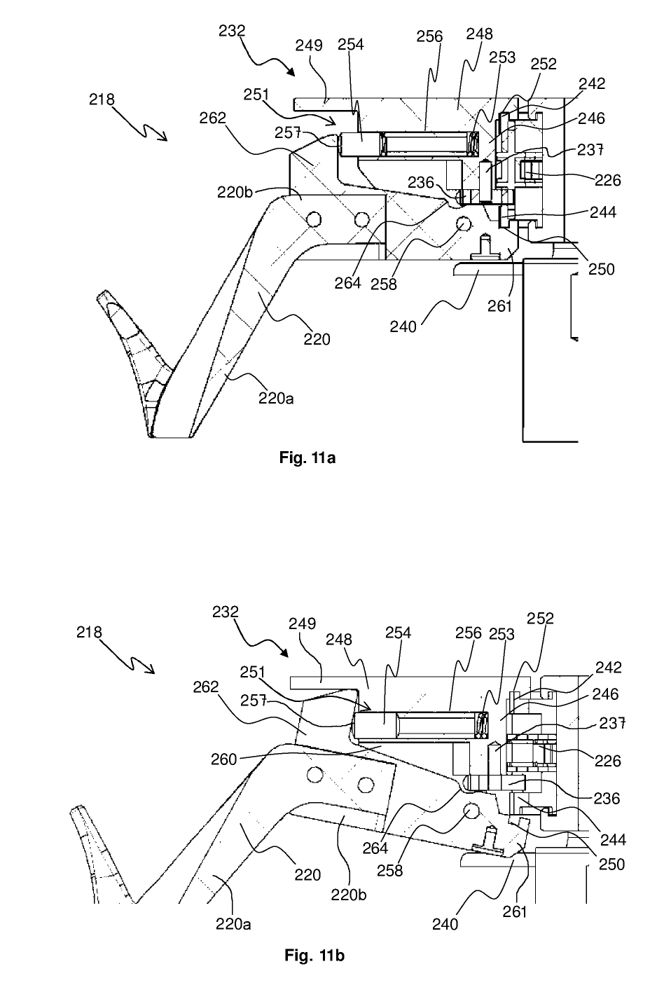

FIGS. 9a-11b illustrate another embodiment of a suspension apparatus 218 in a first position (FIGS. 9a, 9b, and 11a) and a second position (FIGS. 10a, 10b, and 11b). FIG. 9a shows the suspension apparatus 218 according to the invention in a first position. The suspension apparatus 218 includes a guide and drive device having a drive element 226, on which a securing element 232 of a hook 220 is hung. The hook 220 is coupled by a mounting pin 258 to the securing element 232. A detailed view of the assembly of the suspension apparatus 218 is shown in FIGS. 11a and 11b and described in further detail below.

The drive element 226 includes a chain which is equipped at upper and lower sides with a plurality of sliding guide members 242 and 244. The sliding guide members 242 and 244 are respectively arranged in a row so as to be rail-like for guiding the suspension apparatus 218, along the longitudinal axis thereof. The sliding guide members 242, 244 each have a securing sleeve 242a, 244a for connection to the chain of the drive element 226. The sliding guide members 242, 244 each also include a slide shoe 242b, 244b configured to be coupled to respective grooves 250 and 252 of the securing element 232 or the hook 220. The drive element 226 is displaceable both in the horizontal direction and also in a direction inclined relative to the horizontal, as shown in FIGS. 9a and 10a.

The sectional view in FIGS. 11a and 11b shows that the securing portion 232 includes two limbs 246 and 248 arranged at a right angle to each other. The first limb 246 includes the groove 252 and a gear wheel 236. The first limb 246 is positioned substantially vertically, parallel, and adjacent to the drive element 226. The groove 252 engages the sliding guide member 242 of the drive element 226 and maintains the position of the securing element 232. The gear wheel 236 is disposed at the free end of the first limb 246 and is mounted rotatably by a vertical mounting pin 237 to the first limb 246. The gear wheel 236 is mounted rotatably to the vertical mounting pin 237 and bears directly against the free end of the first limb 246. In addition, the gear wheel 236 engages laterally into the drive element 226 and together with the groove 252 allows parallel guidance of the securing element 232 along the drive element 226. The gear wheel 236 supports the securing element 232 in relation to the drive element 226 and holds the securing element 232 in the desired horizontal position.

In addition, the securing element 232 includes two side walls 260 which are bounded at two sides by the two limbs 246, 248 and together define an intermediate space. The edge of the side walls 260 remote from the limbs 246, 248 is angled in such a way that the side walls 260 define an overall triangular shape.

The second limb 248 includes a shoulder 249 at a free end that narrows the wall thickness of the second limb 248. A blind bore 256 is provided within the second limb 248 adjacent the shoulder 249, extending horizontally and being open towards the shoulder 249. Disposed within the blind bore 256 is a spring element 251 which is made up of two components. The spring element 251 includes a pressure receiving member 254 adjoining a coil spring 253 at the bottom of the blind bore 256. The diameter of the pressure receiving member 254 corresponds to the diameter of the blind bore 256 and is of a suitable length to arrange the spring element 251 concentrically within the blind bore 256. The free contact surface 257 of the pressure receiving member 254 has a slight curvature.

The hook 220 is mounted pivotally by the mounting pin 258 within the intermediate space in the securing element 232 between the side walls 260 thereof. In a proximal region 261 in relation to the drive element 226, the hook 220 has a bore into which the mounting pin 258 engages. In the proximal region 261, the hook 220 also includes the groove 250 and a curved opening 264. In the first position of the hook 220, the groove 250 is disposed in engagement with the lower sliding guide member 244. In the first position, the proximal region 261 of the hook 220 engages the gear wheel 236 along a bottom surface to prevent rotation of the gear wheel 236. The curved opening 264 is configured such that the hook 220 does not collide with the end face of the gear wheel 236 in any position of the hook 220.

In the area of the spring element 251 of the securing element 232, the hook 220 includes a projection 262, which interacts with the pressure receiving member 254 of the spring element 251. The projection 262 on the hook 220 is configured to be parallel to the contact surface 257 of the pressure receiving member 254 in the first position of the hook 220. Thus, an almost point-like contact between the pressure receiving member 254 and the projection 262 is enabled. The point contact between these components becomes progressively more like a surface contact as the hook 220 is pivoted towards the second position.

The hook 220 consists of a two-part structure, wherein one part 220a forms the hook arm on which the sausages are hung, and the second part 220b provides the coupling to the securing element 232 and the drive element 226. The two parts 220a, 220b of the hook 220 are connected together by means of bolts. It would also be possible to envisage a one-piece construction for the hook 220.

An abutment 240 of plate-like shape is arranged below the drive element 226. The abutment 240 is positioned so that, as soon as the hook 220 is in the second position, the hook 220 can be oriented at the abutment 240, as shown on an enlarged scale in FIGS. 10b and 11b. In the first position, the path of movement of the hook 220 does not cross over the abutment 240, as shown in FIGS. 9b and 11a.

To adjust the suspension apparatus 218 for suspending strings of sausages, the abutment 240 is moved into a reference position. The hook 220 is then displaced into the second position in which the groove 250 in the hook 220 is uncoupled from the sliding guide member 244 and is thus displaceable relative to the drive element 226. To pivot the hook 220 into the second position, the hook 220 is rotated about mounting pin 258. A moment about the mounting pin 258 is produced thereby, which causes the pivotal movement of the hook 220. The pivotal movement of the hook 220 is limited by the projection 262 abutting against the shoulder 249 of the second limb 248. In addition, the surface contact between the hook 220 and the gear wheel 236 is discontinued in the second position so that the gear wheel 236 is released for rotation.

In the second position, the spring element 251 is compressed by the projection 262, but only to such an extent that it is not pressed completely within the bore 256. The securing element 232 remains unchanged in the first and the second positions of the hook 220. After the hook 220 has been displaced into its second position, the hook 220 together with the securing element 232 is displaced to the abutment 240 along the drive element 226 and is oriented at the abutment 240. The hook 220 is then displaced back into its first position again, by the hook 220 being released. The spring pressure force of the spring element 251 causes the hook 220 to be pivoted back into the first position again, such that the hook 220 engages with its groove 250 into the sliding guide member 244 of the drive element 226. The moment permanently acting on the hook 220, due to the spring pressure force, ensures that the suspension apparatus 218 remains secured in a tongs-like relationship by the two grooves 250 and 252 to the drive element 226. This relationship ensures reliable transmission of force from the drive element 226 to the suspension apparatus 218.

In the first position of the hook 220, the drive element 226 is further displaced by a defined desired distance. Repetition of the aforementioned method steps with a further hook 220 provides that a row of hooks 220 are secured in a spaced row with each other along the drive element 226.

The hooks 220 can therefore be removed together with the securing element 232 from the drive element 226 of the guide and drive device, or added to the drive element 226. That provides for the guide and drive device being quickly and easily equipped with the desired number of hooks 220 for suspending the string of sausages 12.

1-18. (canceled)

19. An apparatus for suspending strings of sausages in loops, comprising:
a plurality of hooks configured to carry a loop of the strings of sausages;
a guide and drive device including a circulating drive element configured to receive the plurality of hooks and to drive the plurality of hooks along a path of movement; and
a fixing device on each of the plurality of hooks and configured to steplessly locate the hook in spaced relation relative to adjacent hooks on the drive element.

20. The apparatus of claim 19, wherein the drive element includes a plurality of recesses and the fixing device further comprises:
a gear wheel rotatably mounted on the hook and including teeth configured to engage the plurality of recesses of the drive element; and
a locking device configured to prevent rotation of the gear wheel.

21. The apparatus of claim 20, wherein the drive element further comprises a toothed belt or chain defining the plurality of recesses.

22. The apparatus of claim 20, wherein each of the plurality of hooks includes a securing portion, and each corresponding gear wheel is rotatably mounted on the securing portion along a substantially vertical axis of rotation.

23. The apparatus of claim 22, wherein the locking device includes a threaded bolt cooperating with the gear wheel and a nut configured to engage the threaded bolt to the securing portion to thereby prevent rotation of the gear wheel.

24. The apparatus of claim 22, wherein the guide and drive device includes a guide rail, and wherein the securing portion of each of the plurality of hooks is substantially U-shaped and includes two opposing limbs cooperating with the guide rail along the path of movement.

25. The apparatus of claim 24, wherein the guide rail further comprises at least one substantially vertical plate configured to slidably engage the plurality of hooks.

26. The apparatus of claim 22, wherein each of the plurality of hooks further includes a suspension portion adjacent to the securing portion, the suspension portion configured to support a string of sausages.

27. The apparatus of 19, wherein each of the plurality of hooks is displaceable from a first position to a second position in relation to the drive element.

28. The apparatus of claim 27, wherein each of the plurality of hooks includes a securing element pivotally coupled to the hook about an axis substantially parallel to the drive element.

29. The apparatus of claim 28, wherein each of the plurality of hooks rotates about the securing element from the first position to the second position, the hook being fixedly coupled to the drive element in the first position, the hook being uncoupled from the drive element in the second position.

30. The apparatus of claim 29, wherein the fixing device includes a gear wheel rotatably mounted on the securing element, the hook preventing rotation of the gear wheel in the first position and enabling rotation of the gear wheel in the second position.

31. The apparatus of claim 19, further comprising:
an abutment adjacent to the guide and drive device and configured to orient the plurality of hooks.

32. The apparatus of claim 31, wherein the abutment is displaceable into a reference position for orienting the plurality of hooks.

33. A method of adjusting an apparatus for suspending strings of sausages, the apparatus including a plurality of hooks for carrying the strings of sausages and a guide and drive device with a circulating drive element for driving the plurality of hooks along a path of movement, the method comprising:
attaching an abutment to the guide and drive device in a reference position configured to properly orient the plurality of hooks;
moving one of the plurality of hooks from a first position fixedly coupled to the drive element to a second position wherein the hook is uncoupled from and displaceable relative to the drive element;
moving the hook to the abutment;
moving the hook at the abutment into the first position wherein the hook is fixedly coupled to the drive element; and
moving the hook along the path of movement past the abutment.

34. The method of claim 33, wherein the abutment may be attached to the guide and drive device automatically by a control and drive device.

35. The method of claim 33, further comprising:
removing surplus hooks from the guide and drive device after movement of the hook to the second position.

36. The method of claim 33, further comprising:
adding hooks to the guide and drive device after movement of the hook to the second position.
